(19) United States
(12) Patent Application Publication
(10) Pub. No.: US 2026/0135862 A1
(43) Pub. Date: May 14, 2026

(54) BEHAVIOR PATTERN IDENTIFICATION AND EXTRACTION FROM UNIQUE TRAITS OF ACTIVITIES IN TIME-SERIES DATA

(71) Applicant: PAYPAL, INC., San Jose, CA (US)

(72) Inventor: Shitong Huang, Shanghai (CN)

(21) Appl. No.: 18/944,795

(22) Filed: Nov. 12, 2024

(51) Int. Cl. H04L 9/40; H04L 67/50

(52) U.S. Cl. CPC H04L 63/1416; H04L 67/535

(57) ABSTRACT

Computer security improvements relating to defenses using behavior pattern identification and extraction from unique traits of activities in time-series data are disclosed. A service provider may utilize a framework having computing operations for detecting and protecting from fraud and other behaviors indicative of risk, account takeovers, or other malicious activity. In this regard, the service provider may utilize a pattern analysis tool that may analyze computing log histories for account activities performed by devices using digital accounts. The activities may be correlated based on their traits having the same or similar data values, where sharing of these traits for activities at or over a threshold with a target account group in contrast to another account group may indicate a particular behavior. Behavior patterns may be extracted by comparing the activities by their traits in the target group, and the behavior patterns may be used for AI model training.

### TECHNICAL FIELD

The present application generally relates to detection of patterns from computing device activities, and more particularly to identifying and generating behavior patterns associated with use of digital accounts from time-series data of account activities.

### BACKGROUND

As hackers and other malicious entities become more sophisticated, they may perform different computing attacks and other malicious conduct. For example, malicious actors may attempt to gain access to sensitive identification and/or authentication information, or otherwise compromise computer security credentials. Service providers may thus utilize security threat detection systems to identify suspicious behavior and malicious activities. However, security threat detection systems may be complex, and deploying a solution in a live production computing environment may take considerable time. Fraud, account takeovers (ATOs), money laundering schemes, and the like are constantly changing, and new strategies, vulnerabilities, or other techniques by which fraud can be conducted are increasingly being used by bad actors. As such, intelligent systems for automating fraud detection and prevention require more advanced and evolving techniques and solutions trained from complex behavior patterns. Consequently, there is a need to streamline the labor-intensive and time-consuming aspects of data processing for pattern recognition in user and account activities, so that an efficient process for behavior pattern identification may be provided for risk modeling. Once fraud or risk is detected, actions can be taken to address the fraud or risk, thereby minimizing or eliminating the adverse results of malicious conduct.

### BRIEF DESCRIPTION OF THE DRAWINGS

FIG. 1 is a block diagram of a networked system suitable for implementing the processes described herein, according to an embodiment;

FIG. 2 is an exemplary diagram of the execution steps of a behavior extractor tool that may determine behavior patterns for account activities having shared traits, according to an embodiment;

FIGS. 3A-3C are exemplary user interfaces of a behavior extractor tool when determining behavior patterns from account activities having shared traits, according to an embodiment;

FIG. 4 is a flowchart for behavior pattern identification and extraction from unique traits of activities in time-series data; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for behavior pattern identification and extraction from unique traits of activities in time-series data. Systems suitable for practicing methods of the present disclosure are also provided. Note that while various examples, structures, techniques, etc. may be described with respect to a service provider in this specification, these structures, techniques, etc. are generalizable and are applicable to any entity that implements security systems and defenses using and/or based on the behavior pattern identification and extraction described herein, according to various embodiments.

In an entity's (e.g., service provider's) systems, such as online platforms and systems that allow users to interact with, use, and request data processing, the entity may provide a computing architecture that may face different types of fraud and computing attacks coming from malicious sources over a network. Fraud may include unlawful and/or unauthorized transactions, which may cause loss for customers including individual users and merchants or other business entities, as well as loss for the service provider (e.g., an online transaction processor). Computing attacks against the service provider may include ATOs, where a malicious entity (e.g. fraudster) may gain access to an account and/or otherwise compromise the account to engage in fraudulent, malicious, and/or illegitimate actions or operations with the account. As such, fraud and other malicious computing attacks and activities may be performed through digital accounts of users, such as a digital payment account with an online transaction processor. A malicious actor may initiate a computing attack to compromise accounts, computing services, products, data, and/or financial instruments and funds in the computing environment of the service provider. Fraudsters may also compromise accounts and computing systems through unauthorized acquisition of sensitive personal, financial, and/or authentication information from users, such as through malware, phishing attacks, and the like.

To reduce risk, fraud, and loss, online transaction processors and other online service providers may implement a security and threat detection system. Conventionally within a risk system, models and strategies may be capable of identifying some fraudsters based on simple fraud patterns, behaviors, and trends in activities. However, these conventional systems are not capable of understanding and identifying more complex fraud patterns and trends. For those complex trends, relying solely on isolated data at a transaction point is no longer sufficient to recognize these complex or newer attacks with sufficient accuracy or timeliness. Risk and fraud detection systems may therefore benefit from a more holistic view and comprehensive understanding of user behaviors to uncover these patterns in activities of fraudsters and other users when utilizing accounts, online computing services and platforms, applications/websites, and the like. Obtaining the necessary data to identify these patterns of account activities and other account uses or interactions may involve extensive and redundant data processing tasks. As such, recognizing these patterns with different activities across different processing flows and user experiences (UXs) becomes a challenging endeavor, which requires significant system resources to process this account activity and other data.

The account activity and other data are needed when users engage with various computing services offered by various service providers. To use such computing services, service providers may provide accounts to end users for interaction with other accounts and/or users. A user may wish to process a transaction, such as for a payment to another user or a transfer of currency, including fiat currency, digital currency, cryptocurrency, video game currency, and the like. A user may pay for one or more currency transactions using a digital wallet or other account with an online service provider or transaction processor (e.g., PayPal®). An account may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The account and/or digital wallet may be loaded with currency or currency may otherwise be added to the account or digital wallet. The application or website of the service provider, such as PayPal® or other online payment provider, may provide payments and the other transaction processing services via the account and/or digital wallet.

Once the account and/or digital wallet of the user is established, the user may utilize the account via one or more computing devices, such as a personal computer, tablet computer, mobile smart phone, or the like. Some accounts may be fraudulent or may be compromised by an ATO action by a fraudster. As such, accounts may be established or taken over with the intent to engage in fraudulent activity. In order to provide faster detection of and protection against fraud, ATOs, and/or fraudulent or malicious actors and accounts, the service provider, in various embodiments, may provide operations to automatically identify behavior sequences and/or other relationships between activities in time-series data so that modeling of fraudulent or other identifiable behaviors may be improved and made more accurate, as well as applicable to a larger set of behaviors and activities. This may include use of a search and account activity processing tool that implements a pattern search and identification algorithm that may provide a valuable resource to data identification and extraction for risk modeling and detection systems. For example, the tool may provide end-to-end processes for handling datasets in order to identify behavior patterns, as well as one or more interfaces, such as user interfaces (UIs) displayable by the tool on a computing device, that may present or display representations of the behaviors, behavior trees, and corresponding activities processed to identify behavior patterns.

In this regard, a service provider may provide a tool and/or application that may implement an algorithm, technique, and executable operations designed to identify unique behavior patterns for a target population. The tool may allow users, such as data scientists and/or other users that may perform risk modeling, as well as other systems and/or entities that may be interested in identifying behavior patterns, to upload a dataset of time-series data for activities by users, such as account activities that users performed with a digital account. The dataset may consist of two user and/or account groups, a target and a contrast group, with an account identifier (ID) and timestamp for each activity. However, more groups may also be utilized where different targets and/or comparisons may be desirable. The target group may correspond to the group for analysis of the activities and behavior pattern recognition (e.g., identification of two or more activities that may be temporally related, such as occurring in a time period), such as a group of accounts having ATO flags and/or fraudulent activity, while the contrast group may correspond to nonfraudulent, standardized, and/or a general population, or sampling thereof.

The tool may collect the necessary data based on the given configurations and designated parameters for behavior pattern identification and may use the account ID as a join key to track historical event-based data for the user over N-days. For example, with account activities, each “checkpoint” in account data and/or logs may correspond to an activity, such as an “add credit card” checkpoint or a “send money” request. Each checkpoint may have a corresponding variable, which may correspond to the trait or particular data for that activity. For example, a variable may correspond to the corresponding data for the checkpoint in a log, such as the information for adding a credit card or the user/amount sent via a send money request. As such, the variables may correspond to the traits that describe or are associated with the activity.

The tool for behavior pattern identification may then identify the most relevant and unique traits for each kind of activity and combine the activities by their traits to maximize the differentiation between the target and contrast population. Once differentiated from the contrast population, the activities by the target population may be combined into “trees” or patterns or series of activities connected together to allow for searching for multi-activity behavior patterns. These may correspond to a series of actions, such as login through a suspicious internet protocol (IP) address to make a purchase using a specific credit card and/or bank identification number (BIN) that are indicative of a particular behavior or intent. Finally, the tool may filter the behavior patterns and retain the patterns that match the parameters and/or other criteria for behavior pattern identification and search.

The patterns may contain information that may be indicative of a potential trend, such as behaviors indicating or leading up to fraud, behaviors performed during an ATO that were fraudulent, and the like. As such, the tool may not only analyze data from a single party, such as either the sender or the receiver in a transaction but also may analyze bilateral searches that combine both sender and receiver information temporally related over a time period based on their activities and corresponding traits. This enhancement uncovers complex trend patterns, revealing concentrated behaviors that parties may exhibit, thus offering a more comprehensive view of potential fraud activities or other behaviors of interest. In this manner, improved and more precise training data may be provided for ML model training, which allows for more accurate and reliable automated systems for behavior pattern identification. By identifying and correlating specific activities and/or sequences of activities into behavior patterns, malicious accounts may be identified, and their corresponding account data and ML feature data may be used for improved ML modeling and AI system automations. These behavior patterns may be identified without requiring manual identification and configuration, which may take considerable time and effort. As such, AI systems may be trained significantly faster and more efficiently, while providing more accurate models and detection capabilities for a wide range of complex behavior patterns, which results in quicker and more relevant actions that can be taken to mitigate or eliminate fraud and other computing attacks.

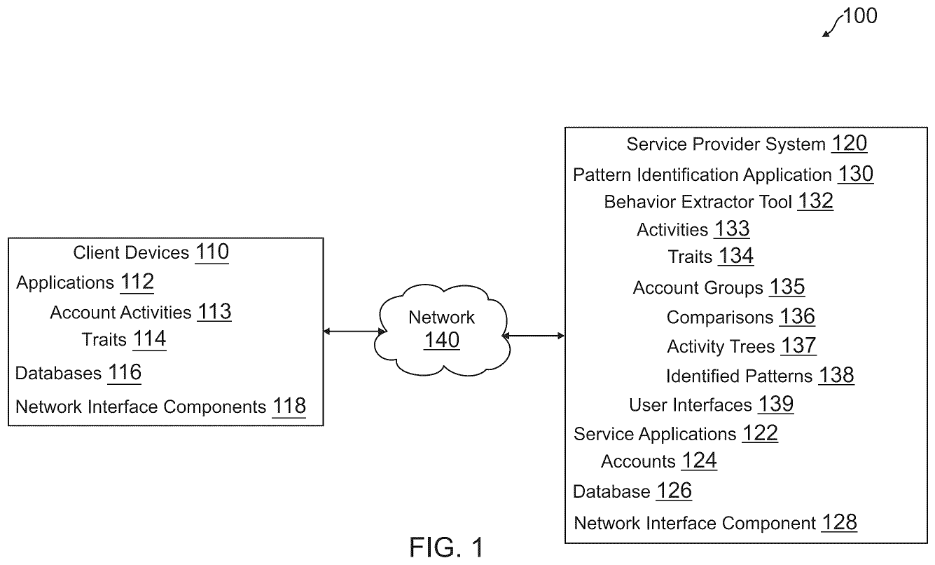

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

System 100 includes client devices 110 and a service provider system 120 in communication over a network 140. Client devices 110 may be utilized by a valid user of an account, or instead may be used by a malicious user or other bad actor to perform fraudulent activity using an account over network 140. Service provider system 120 may provide various data, operations, and other functions over network 140 in order to identify if accounts used by client devices 110 may be compromised, and therefore engaging in fraudulent activity. In this regard, service provider system 120 may automate processes to identify behavior patterns from account activities using a tool for tracing and correlating common traits for those account activities between target and contrast groups. These behavior patterns may then be used for modeling of ML models for fraud detection.

Client devices 110 and service provider system 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

Client devices 110 may be implemented as a communication device that may utilize appropriate hardware and software configured for wired and/or wireless communication with service provider system 120. For example, in one embodiment, client devices 110 may be implemented as a personal computer (PC), a smart phone, laptop/tablet computer, wristwatch with appropriate computer hardware resources, eyeglasses with appropriate computer hardware (e.g., GOOGLE GLASS ®), other type of wearable computing device, implantable communication devices, and/or other types of computing devices capable of transmitting and/or receiving data. Although a plurality of client devices are shown, individual devices may be used and/or function similarly and/or be connected to provide the functionalities described herein, some of which are used to engage in authorized actions/activities, while others are used to engage in fraudulent or unauthorized actions/activities.

Client devices 110 of FIG. 1 contains applications 112, databases 116, and network interface components 118. Applications 112 may correspond to executable processes, procedures, and/or applications with associated hardware. In other embodiments, client devices 110 may include additional or different modules having specialized hardware and/or software as required.

Applications 112 may include different processes executable by software modules and associated components of client devices 110 to provide features, services, and other operations to users, which may include accessing and/or interacting with service provider system 120, for example, utilizing digital accounts to process transactions, payments, or transfers or otherwise engage in account activities 113. In this regard, applications 112 may correspond to computing software utilized by users of client devices 110 to access a website or UI provided by service provider system 120 or another entity (e.g., merchant, service provider, partner or third-party platform associated with service provider system 120) to perform actions or operations using a digital account. In various embodiments, applications 112 may correspond to a general browser application configured to retrieve, present, and communicate information over the Internet (e.g., utilize resources on the World Wide Web) or a private network. For example, applications 112 may provide a web browser, which may send and receive information over network 140, including retrieving website information (e.g., a website for a merchant), presenting the website information to the user, and/or communicating information to the website including navigating between webpages to login to accounts, process transactions, and/or otherwise utilize computing services.

However, in other embodiments, applications 112 may include a dedicated software application of service provider system 120 or other entity (e.g., a merchant) resident on client devices 110 (e.g., a mobile application on a mobile device), which may be configured to view and utilize data via user interfaces (e.g., applications interfaces displayable by a graphical user interface (GUI) associated with applications 112) and request execution of computing operations when utilizing accounts with service provider system 120. Applications 112 may provide one or more of user interfaces, for example, via graphical user interfaces (GUIs) presented using an output display device of client devices 110, to enable the user associated with client devices 110 to utilize computing services, platforms, and applications of service provider server with accounts, which may request execution of computing operations through user interface commands and other user inputs.

Applications 112 may provide transaction processing, such as through a user interface enabling the user to enter and/or view a transaction for processing. This may be based on a transaction generated by applications 112 using a service provider platform or website, merchant marketplace, or by performing peer-to-peer transfers and payments via service provider system 120 in conjunction with another account and/or computing device. Applications 112 may access accounts and view and/or utilize account information, user financial information, and/or transaction histories. In some embodiments, different services may be provided by service provider system 120 via applications 112 including social networking, messaging, media posting or sharing, microblogging, data browsing and searching, online shopping, and other services available through service provider system 120. Thus, applications 112 may also correspond to different service applications and the like that are associated with service provider system 120.

When using applications 112 from client devices 110, a fraudster or other bad actor may engage in fraud and/or other malicious conduct, such as performing fraud through an ATO using compromised credentials. As such, applications 112 may be used to access accounts and use the accounts to conduct fraud with other accounts, sellers or merchants, financial institutions, and the like. However, other ones of client devices 110 may use applications 112 to conduct valid or authorized transactions through user accounts. As such, when using applications 112 with service provider system 120 to access and utilize accounts provided by service provider system 120 (either validly or fraudulently), computing operations and activities may be requested and/or executed through the accounts corresponding to account activities 113. Account activities 113 may include computing operations and/or activities executed by client devices 110 via user interfaces and corresponding data, operations, and the like. As such, applications 112 may be used to execute user commands based on user requests, inputs, and the like that correspond to different account usages and activities. Account activities 113 may request data processing with or using the requested account in response to one or more inputs, commands, API calls or requests, navigations, and the like. Account activities 113 include traits 114, which may correspond to different computing log fields or data recorded and/or tracked for the account activity, such as a login field and value provided in the login field (e.g., “Login: Alice123”). Account activities 113 may correspond to different checkpoints during a processing flow, UX, or the like, and traits 114 may therefore include the data detected, recorded, or logged for the particular instance of that checkpoint and account activity performed by or using the corresponding account. Account activities 113 may be received and/or logged by service provider system 120, and a corresponding computing log may include data that records and/or identifies account activities 113 that are performed by client devices 110 when using a corresponding account with service provider system 120.

Client devices 110 may further include or have access to databases 116, which may correspond to different types of data storage and components including cloud computing storage nodes, remote data stores and database systems, distributed database systems over network 140, and the like used to store various applications and data. Databases 116 may include, for example, identifiers such as operating system registry entries, cookies associated with applications 112 and/or other applications, identifiers associated with hardware of client devices 110, or other appropriate identifiers, such as identifiers used for payment/user/device authentication or identification, which may be communicated as identifying the users/client devices 110 to service provider system 120.

Client devices 110 includes at least one network interface components 118 adapted to communicate with service provider system 120 and/or another device or server over network 140 for electronic transaction processing and other computing services. In various embodiments, network interface components 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider system 120 may be maintained, for example, by an online service provider, which may provide fraud detection and protection systems for computing systems and infrastructure of service provider system 120. In this regard, service provider system 120 includes one or more processing applications which may be configured to interact with client devices 110 to determine whether client devices 110 are acting fraudulently or utilizing accounts in a fraudulent manner. This may be done using ML models trained on behavior patterns determined using an automated tool that analyzes account activities for shared traits. In one example, service provider system 120 may be provided by PAYPAL®, Inc. of San Jose, CA, USA. However, in other embodiments, service provider system 120 may be maintained by or include another type of service provider.

Service provider system 120 of FIG. 1 includes a pattern identification application 130, service applications 122, a database 126, and a network interface component 128. Service applications 122 and pattern identification application 130 may correspond to executable processes, procedures, and/or applications with associated hardware. In other embodiments, service provider system 120 may include additional or different modules having specialized hardware and/or software as required.

Pattern identification application 130 may correspond to one or more processes to execute modules and associated specialized hardware of service provider system 120 to provide operations, an application, and/or a framework for a behavior extractor tool 132 used to analyze activities 133 based on traits 134 that may be shared between accounts provided by service provider system 120. In this regard, pattern identification application 130 may correspond to specialized hardware and/or software used by service provider system 120 to monitor account activities for behavior extraction, including account activities 113 from client devices 110. Activities 133 may be extracted from monitored computing logs (e.g., network, firewall, or other logs) and/or tracked data for activities 133 and may then be processed in trees that are correlated for behavior patterns or sequences in activities 133. Further, pattern identification application 130 may verify that the behavior patterns meet the requested and/or designated search parameters for behavior pattern identification.

In this regard, pattern identification application 130 may include different operations for detection of behavior patterns using behavior extractor tool 132. Activities 133 may be selected for analysis, and traits 134 may correspond to the data variables, features, or log fields that may be used to correlate certain activities across different accounts based on being shared and/or having the same or similar values or other data for traits 134. A set of accounts may be identified and may include at least two sets with different groupings and/or designations corresponding to account groups 135. For example, account groups 135 may include a control group and a target group, where the control group may include normal or standard accounts, such as those without fraud flags or other identified suspicious behaviors. The target group for account groups 135 may correspond to the group that has a behavior that is selected or identified for tracking and identification with other accounts, such as those with fraud flags or otherwise identified as being associated with fraudulent behavior. As such, the target group may be annotated with a particular behavior, which may be analyzed and detected based on activities 133 sharing one or more of traits 134 with the same or similar data. Account groups 135 may correspond to all or a subset of all accounts (e.g., a sampling for the control and/or target group), as well as a specific demographic or type of accounts (e.g., US accounts, merchant accounts, etc.) provided by service provider system 120 so that the subset identifies a population of accounts having an ATO indication or other fraud alert.

Activities 133 may include time-series data for traits 134, which may be used instead of tabular data that may be unavailable or undesirable for behavior pattern identification. For example, the time-series data for activities 133 may include data points recorded over a period of time and/or at intervals usable to identify trends and behavior patterns in activities 133. Activities 133 may be determined from a network traffic, system event, and/or other computing log generated from interactions by client devices 110 with service provider system 120 including machine data and identifiers, IP addresses, payloads, endpoints, API calls and requests, and/or other data relevant to a behavior. A user may specify parameters for behavior pattern identification, such as conditions and/or thresholds for occurrence of one or more of activities 133 sharing one or more of traits 134 over a number of the target accounts. Thus, the parameters may specify those of activities 133 to search, traits 134 that may be required to be shared, and/or the number or other threshold of the target accounts over which those occur. Comparison 136 may be generated from processing activities 133 based on these parameters, and comparisons 136 may be used to generate activity trees 137. Comparisons 136 may be performed by comparing activities 133 with traits 134 over the target and control groups to identify those of activities 133 sharing one or more of traits 134 having the same or similar data that occur with the target account group, but not or less frequently with the control group.

Activity trees 137 may correspond to trees or other diagrams of the activities and their links over corresponding ones of activities 133, which may represent how the activities occur over the time-series data. Activity trees 137 may be generated through combinations of traits 134 for activities 133, which may generate the tree links between activities 133 sharing traits 134 that have been identified. Activity trees 137 may then be processed by searching for patterns that qualify, meet, or may be verified according to the parameters for behavior parameter identification. For example, criteria, such as a baseline pattern, occurrence threshold, or the like, may be used to determine identified patterns 138 that qualify based on the parameters. Thereafter, identified patterns 138 may be used for modeling of one or more AI models, such as ML models or NNs for fraud detection or other account behavior identification.

An AI engine for service provider system 120, such as one used by service applications 122 for fraud detection, risk analysis, compliance, or other account identification and detection based on behavior pattern identification, may include one or more AI or ML models, NNs, conversational AIs, or the like. These AI models may be trained using identified patterns 138 and other training data generated by pattern identification application 130, such as based on behavior patterns requested by users and extracted using behavior extractor tool 132. AI models may have trained layers based on training data and selected features or data variables from identified patterns 138 and other outputs of pattern identification application 130. For example, ML features or variables may correspond to individual pieces, properties, characteristics, or other inputs for an ML model and may be used to cause an output by that ML model once the ML model has been trained using data for those features from training data. AI models may be used for computation and calculation of model scores, such as fraud detection scores, assessments, or predictions, based on layers, nodes, branches, clusters, rules, and the like that are trained and optimized. As such, ML models may be trained to provide a predictive output, such as a score, likelihood, probability, or decision, associated with a particular prediction, classification, or categorization.

AI models may include DNNs, MLs, LLMs, generative AIs, or other AI models trained using training data having data records that have columns or other data representations and stored data values (e.g., in rows for the data tables having feature columns) for the features. When building AI models, training data may be used to generate one or more classifiers and provide recommendations, predictions, or other outputs based on those classifications and an ML or NN model algorithm and architecture. The algorithm and architecture for the AI models may correspond to DNNs, ML decision trees and/or clustering, conversational AIs, LLMs, generative AI, and other types of AI, ML, and/or NN architectures. The training data may be used to determine features, such as through feature extraction and feature selection using the input training data.

DNN models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a DNN algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for ML models that attempt to classify and/or categorize the input feature data and/or data records, such as by classifying accounts based on account behaviors patterns and activities. Thus, when the AI models are used to perform a predictive analysis and output, the input data may provide a corresponding output based on the trained classifications.

Layers, branches, clusters, or the like of the AI models may be trained by using training data associated with data records of interest, such as onboarding options, computing services, personalized assistance responses, available and/or required data for onboarding tasks and goals, and the like. By providing training data, the nodes in the hidden layer may be trained (adjusted) such that an optimal output (e.g., a classification) is produced in the output layer based on the training data. By continuously providing different sets of training data and/or penalizing the AI models when the outputs are incorrect, the AI models (and specifically, the representations of the nodes in the hidden layer) may be trained (adjusted) to improve its performance in data classifications and predictions. Adjusting of the AI models may include adjusting the weights associated with each node in the hidden layer. As such, these AI models may be trained and configured based on identified patterns 138 and other outputs of pattern identification application 130.

Service applications 122 may correspond to one or more processes to execute modules and associated specialized hardware of service provider system 120 to process a transaction and/or provide other computing services to users. For example, service applications 122 may include a transaction processing application used to process payments and other services to one or more users, merchants, and/or other entities for transactions, where risk analysis, fraud detection, compliance, and other security and/or AI systems may be provided through ML models trained using behavior patterns identified by pattern identification application 130. In some embodiments, activities 133 may be determined, monitored, and/or extracted from interactions with and/or uses of service applications 122 by client devices 110 and/or using digital account provided to client devices 110 via service applications 122 and/or usable with service applications 122 by client devices 110. For example, an account may be used to send and receive payments, including those payments that may be enabled through merchant websites, applications, POS devices, and the like. A payment account may be accessed and/or used through a browser application and/or dedicated payment application executed by client devices 110, such a payment and/or digital wallet application.

A transaction processing application of service applications 122 may process payments and may provide transaction histories to client devices 110 and/or another user's device or account for transaction authorization, approval, or denial of the transaction for placement and/or release of the funds, including transfer of the funds between accounts and access of data. Further, service applications 122 may provide different computing services, including social networking, microblogging, media sharing, messaging, business and consumer platforms, etc. These computing services may be used by users, merchants, customers, and the like through digital accounts, which may generate activities 133 for processing by pattern identification application 130.

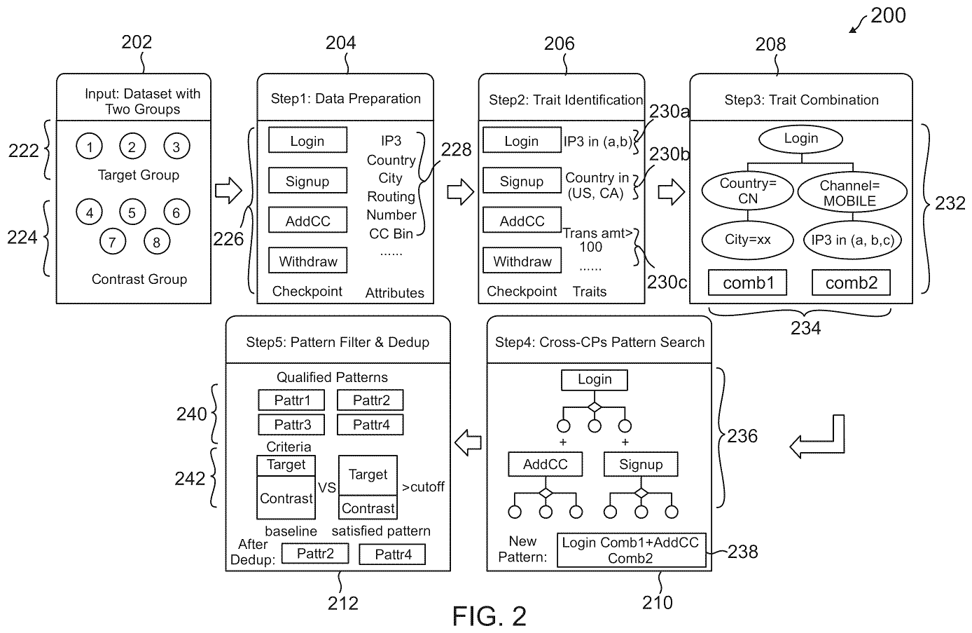

AI models trained using identified patterns 138 and other outputs of pattern identification application 130 may be used for account behavior monitoring and fraud detection/prevention, or other account activity identification. For example, service applications 122 may employ one or more of the trained ML models to perform account activity analysis, behavior pattern identification, and determination of fraudulent activity or other account behavior. In response to detecting fraud, service applications 122 may issue manual challenges, such as CAPTCHA and other requests that may require a user to identify as a human user and/or provide some information so that that user can be verified. This may also include multifactor authentication challenges. These challenges may be issued in response to detecting one or more of identified patterns 138 performed by one or more of client devices 110 during use of an account, such as when performing logins, executing computing operations via the account, engaging in electronic transaction processing, and the like. In further embodiments, identified patterns 138 may be used to bar, prevent, or reverse further activities engaged in by a computing device using a corresponding account, such as a transaction processed using the account. Thus, Pattern identification application 130 may interface with, monitor, and/or exchange data with service applications 122 for extracting and processing activities 133 having traits 134. The operations for intelligent behavior pattern identification and extraction are discussed in further detail with regard to FIGS. 2-4 below.

Service applications 122 further may provide additional features to service provider system 120 for internal and/or external applications, websites, systems, processors, and the like. For example, service applications 122 may include security applications for implementing server-side security features, programmatic client applications for interfacing with appropriate application programming interfaces (APIs) over network 140, or other types of applications. Service applications 122 may contain software programs, executable by a processor, including one or more GUIs and the like, configured to provide an interface to the user when accessing service provider server 110, where the user or other users may interact with the GUI to view and communicate information more easily. Service applications 122 may include additional connection and/or communication applications, which may be utilized to communicate information to over network 140.

Additionally, service provider system 120 includes or may access database 126. Database 126 may store various identifiers associated with client devices 110 and/or other devices and/or servers that may engage and/or interact with accounts, computing services, and/or onboarding processes. Database 126 may also store account data, including payment instruments, financial information, account balances, and authentication credentials, as well as transaction processing histories and data for processed transactions. Database 126 may include information for activities 133 and/or used to extract activities 133 and/or traits 134, such as computing logs, transaction histories, logs of interactions and/or activities at checkpoints in processing flows, and the like. Although database 126 is shown as residing on service provider system 120 as a database, in other embodiments, other types of data storage and components may be used including cloud computing storage nodes, remote data stores and database systems, distributed database systems over network 140 and/or of a computing system associated with service provider system 120, and the like.

In various embodiments, service provider system 120 includes at least one network interface component 128 adapted to communicate with client devices 110 and/or other devices, servers, or resources over network 140 for electronic transaction processing and other computing services. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

FIG. 2 is an exemplary diagram 200 of the execution steps of a behavior extractor tool that may determine behavior patterns for account activities having shared traits, according to an embodiment. Diagram 200 includes a processing flow of steps 202-212 which may correspond to operations executed using pattern identification application 130 of service provider system 120, discussed in reference to system 100 of FIG. 1. In this regard, diagram 200 includes an exemplary execution pipeline of executable tasks at steps 202-212 that may be used to determine and extract behavior patterns from account activities having shared traits.

In diagram 200, initially at step 202, a dataset is accessed and split into groups for analysis, which may include two or more groups or subsets of the data. Where accounts are analyzed for account behavior patterns, step 202 may include splitting the dataset into data for different account groups, such as a target account group 222 and a contrast account group 224. Target account group 222 may correspond to an account group having a particular behavior, action, flag, or other annotation of interest, such as a fraud flag or past fraudulent behavior. Contrast account group 224 may correspond to all or a sampling of a standard or normal account group, such as a general population of accounts that may be taken without consideration of the behavior of interest and/or that do not include the flag or annotation of interest.

For the account group 222, at step 204, one or more data preparation processes may be executed where data is prepared and/or preprocessed so that time-series data and/or other data (e.g., tabular data, when necessary or requested for use) is prepared for an analysis tool, such as behavior extractor tool 132. Data preparation for data may include preprocessing steps, such as data cleaning, normalization, feature selection, reduction, or the like. Data preparation may also include a process to identify the activities and corresponding traits from the dataset, which may correspond to a feature selection process or the like. For example, activities 226 may be determined from checkpoints or other data processing operations or steps in a processing flow. Each of activities 226 may correspond to a particular checkpoint for account usage, which may include a login, a signup, and add credit card (addCC), or a withdraw activity that may be performed using the account. Each one of activities 226 may have corresponding data variables from computing logs of those activities and/or data received or processed with those activities. Data variables may correspond to traits 228 identified for activities 226, such as an IP address, country, city, routing number, credit card bank identification number (CC BIN), and the like. Traits 228 may be used to correlate activities 226 that may be performed by the same or similar user and/or account or may be engaged in the same or similar behavior.

At step 206, trait identification is performed to identify each of traits 228 for activities 226 that have a corresponding value of interest and/or value used for searching activities 226 for behavior pattern extraction. In this regard, a login activity 230a may have a corresponding trait for an IP address, which may have IP address locations or regions of interest for searching and correlating between different activities and accounts for behavior pattern extraction. The traits for the IP address for login activity 230a may correspond to a location a or location b. Similarly, a signup activity 230b may search for signup activities performed in CA, USA, while addCC activity or withdraw activities 230c uses a transaction amount trait of “greater than $100” for searching. The trait identification may therefore identify a subset of traits 228 for activities 226 having particular values of interest and/or for searching and activity tree generation.

At step 208, trait combination is performed to generate an activity tree 232, as well as other activity trees from different trait combinations of activities 226 based on traits 228. Activity tree 232 may be generated by identifying each of activities 226 having the corresponding combination of traits in a tree diagram that correlates each activity by their time-series data and/or temporal occurrence. For example, with login activity 230a, a combination of traits for country and city and a second combination of traits for login channel and IP address may be established to correlate the activity to other activities that occur in relation to login activity 230a. When searching for the traits, the time-series data for target account group 222 may be compared to the time-series data for contrast account group 224 such that the traits that are common between each group may be excluded and instead the traits having corresponding values that are specific to the target account group are identified and extracted. As such, the trait combination for activities may be identified from the traits having values that are particular to the target account group and share at least one trait value of interest from the trait identification performed at step 206 (e.g., from user parameter selection for trait identification and/or behavior pattern searching). Other activities and/or traits may be added to activity tree 232 until a sequence of activities is identified from the traits identified at step 206.

At step 210, a pattern search is performed where patterns of activities are identified based on shared traits and their temporal occurrence or relatedness from the time-series data. For example, with login activity 230a, addCC activity 230b may occur after or during the same login session or period of time associated with a login and account activity (or designated period of time, such as within the last day). Signup activity 230b may also occur with login activity 230a, where each of activities 230a-c share at least one of more of the traits to be linked to the same account and/or account behavior of the account. By performing the pattern search at step 210, the analysis tool may identify a behavior pattern, such as by linked activities 230a and 230b in one sequence and/or activities 230a and 230c in another sequence, as well as activities 230a-c together if each occur within the same time frame, session, or the like.

At step 212, the analysis tool may then perform a filtering, as well as any deduplication or further processing, in order to identify only those behavior patterns that qualify for analysis and output. In this regard, certain parameters may be set for pattern output, such as thresholds for pattern occurrence, activity relationships, number of activities, and the like. Criteria 242 may correspond to those patterns, where the behavior pattern may be required to occur over a baseline amount or threshold in target account group 222 versus contrast account group 224. Deduplication may also identify patterns that are the same or may be duplicated during processing, which may include the same patterns as well as those that include the same activities but may be duplicated due to trait differences. As such, by removing the duplicated patterns, qualification may be more accurate when analyzing the patterns for output. The analysis tool may then output the qualified patterns for ML model training or other AI usage, as well as other analytical tasks. For example, real-time fraud trend prevention may be performed based on training or rules from the qualified patterns, which may monitor for further occurrences of the behavior pattern and take one or more actions to prevent further ATOs and/or fraudulent activities, such as providing manual challenges or performing other security operations to prevent further abuse from fraud.

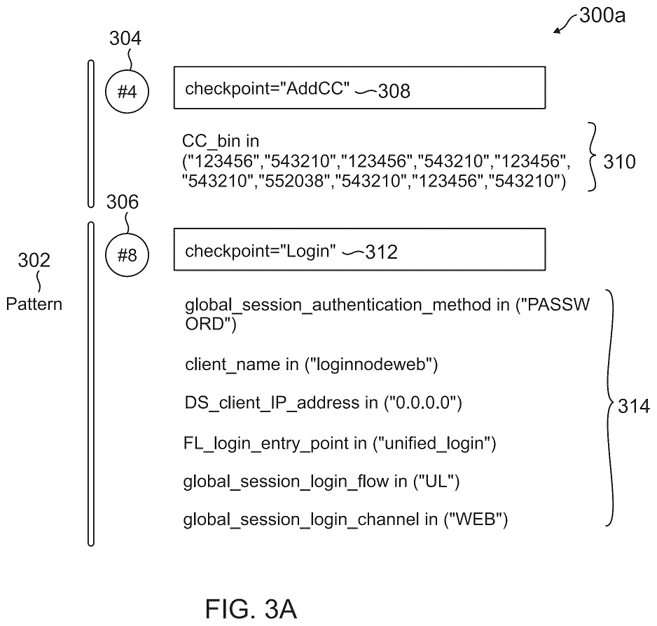

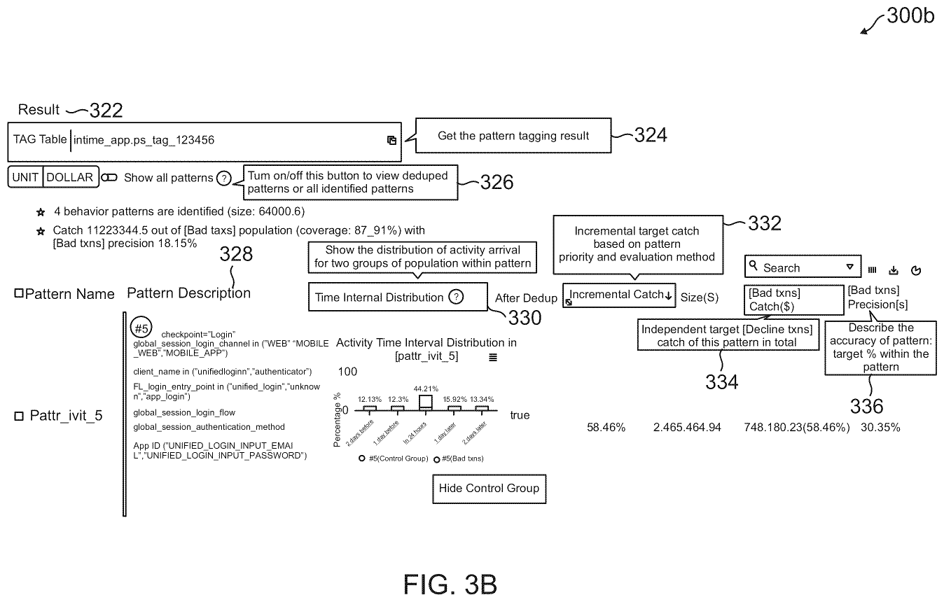

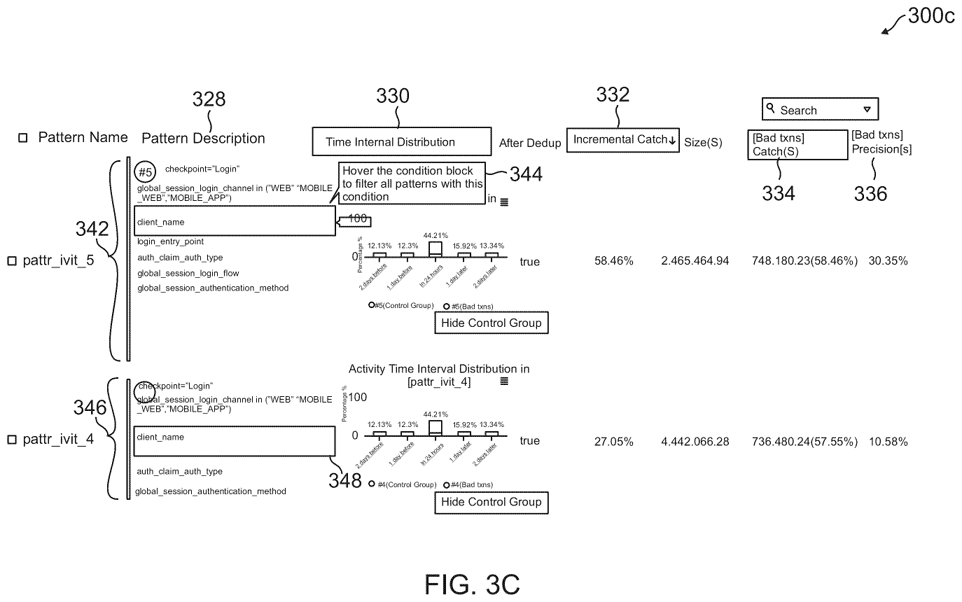

FIGS. 3A-3C are exemplary user interfaces 300a-300c of a behavior extractor tool when determining behavior patterns from account activities having shared traits, according to an embodiment. User interfaces 300a-300c of FIGS. 3A-3C may be displayed by identification application 130 of service provider system 120, discussed in reference to system 100 of FIG. 1, such as when a user (e.g., a data scientist or other user that may perform modeling of one or more AI models) may request identification and extraction of behavior patterns in account activities. As such, user interfaces 300a-300c may include information associated with account activities and their corresponding account behaviors that may be identified based on shared traits.

In user interface 300a, a pattern 302 may be identified from different “checkpoints” or activities during a processing flow or interaction by a device and/or using an account with a service provider's computing services and products. For example, pattern 302 includes a first activity 304 and a second activity 306 identified from multiple activities (e.g., activities numbered 1-10, where first activity 304 may be activity #4 and second activity 306 may be activity #8 or other identification system). For pattern 302, a checkpoint 308 for first activity 304 may correspond to an addCC may have been performed where a credit card was added as a funding instrument to an account. Checkpoint 308 is associated with traits 310, which correspond to variables having data values from logs, histories, or other recorded, tracked, and/or stored data for the activity.

In this regard, traits 310 may include a CC BIN number with corresponding data values. Similarly with a checkpoint 312 for second activity 306, a login may have been performed and traits 314 may include data from the login, such as an authentication method, client name, IP address, login entry point, login flow, login channel, and the like. When identifying first activity 304 and second activity 306 for pattern 302, traits 310 and 314 may be used to help identify those that may be shared or correlated between multiple accounts that have a corresponding flag of interest (e.g., fraud). For example, when searching activities based on their traits across accounts in target and account groups, it may be determined that a set of accounts in the target group performs first activity 304 and second activity 306 all sharing the same or similar data values for traits 310 and 314, respectively. As such, checkpoints 308 and 312 may be correlated and determined to be linked in a pattern or sequence of activity, which may be used to extract pattern 302 for analysis and/or AI model training.

Referring now to user interface 300b, an analysis tool, such as behavior extractor tool 132, may output results 322 of a behavior extraction process that identifies behavior patterns based on their corresponding activities and traits. In this regard, results 322 may include pattern tags 324 that tag each pattern with an identifier after identification and allow for review of each corresponding pattern's activities, traits, and other information, such as temporal association of the activities and the like. A deduplication option 326 may allow a user to view all patterns including those that have been deduplicated (deduped) based on the same or similar activities. Based on selections made in user interface 300b, the user may then view a more detailed analysis of a pattern 328 for results 322.

In user interface 300b, pattern 328 includes a pattern description that lists the corresponding activities or checkpoints with corresponding traits. This allows for the user to identify the activities that are shared between the accounts having fraud flags or other account flags, and further allows for identification of the corresponding traits and their values shared between these accounts and activities. Additionally, a time interval distribution 330 shows a time interval and/or distribution of the time-series data points for the activities over the allowable time period for linking the activities in a behavior patterns. Thus, the user may view an average, longest, shortest, and/or other interval of time that may occur between detection of each activity. An incremental target catch 332 indicates an incremental catch of the determined behavior pattern over the target accounts based on the parameters for searching, and therefore may show a percentage of the account exhibiting the behavior pattern. Additionally, an independent target catch 334 may indicate a number and percentage of the particular pattern over the accounts as a whole or over the target accounts, and a precision 336 may indicate the accuracy of the behavior pattern as indicating fraud when used with a random or selected distribution of account.

Referring now to user interface 300c, results 302 are shown with further detail regarding the activities and traits, as well as their corresponding detection attributes and parameters from behavior pattern searching. In user interface 300c, a user may view selectable information for a first activity 342 with selectable traits for pattern 328 and a second activity 346 with selectable traits for pattern 328. With first activity 342, a user may hover or select a first trait 344, which may be used to add the trait as a condition to filter behavior patterns. Similarly, with second activity 346, a second trait 348 may be selected in a similar manner to add as a condition for behavior pattern filtering. Conditions and other parameters for behavior pattern identification may therefore be identified in this manner and added to the parameter by which behavior patterns are identified and extracted from the activities and their corresponding traits. As such, any pattern with first trait 344 and/or second trait 348 may be filtered (either for specific display or removal from the displayed patterns), and a user may more precisely identify the corresponding behavior patterns of interest.

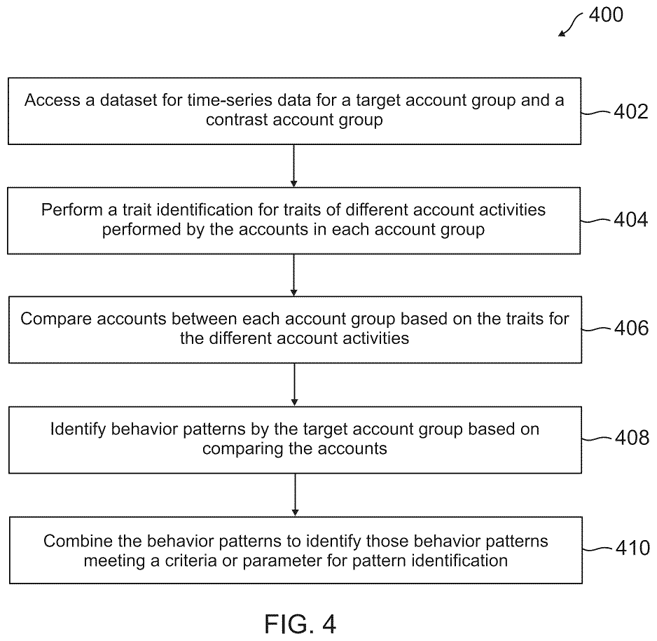

FIG. 4 is a flowchart 400 for behavior pattern identification and extraction from unique traits of activities in time-series data with reference to FIG. 1. Note that one or more steps, processes, and methods described herein of flowchart 400 may be omitted, performed in a different sequence, or combined as desired or appropriate.

At step 402 of flowchart 400, a dataset for time-series data for a target account group and a contrast account group is accessed. Service provider system 120 may detect, collect, and/or retrieve, from storage or third-party services, activities 133 for account groups 135. Activities 133 may be based on uses of service applications 122 by the accounts in account groups 135. The dataset may correspond to time-series account data, such as points at intervals over a time period, and may correspond to account logs, history, monitored behavior or activities, and/or other data about computing operations engaged in by computing devices using the accounts. For example, the dataset for activities 133 may include time-series data for the operations and activities performed by client device 110 when using digital accounts with a computing service, platform, or application provided by a service provider including login, changing account data, interacting with other online entities and/or accounts, and the like. The accounts for which the dataset is accessed may include all or a sampling of normal, standard, unannotated, or non-flagged accounts (e.g., randomly selected or procedural determined from a general population of accounts), which may correspond to the contrast account group, as well as all or a sampling of accounts having a specific behavior, flag, or annotation, such as fraudulent accounts having fraudulent or spoofed transactions, ATO, fraudulent activity, and the like.

At step 404, a trait identification is performed for traits of different account activities performed by the accounts in each account group. Behavior extractor tool 132 may receive the dataset and the identification of the target and contrast groups, as well as any additional parameters used for behavior pattern identification, such as a number of accounts over which a behavior is to be identified, a number of shared traits for an activity correlation, a number of activities required for a behavior, and the like. As such, behavior extractor tool 132 may analyze activities 133 to determine traits 134 for those activities, which may correspond to particular data variables (e.g., for transaction activities or checkpoints, variables such as location, device ID, IP address, account ID, sender/recipient accounts, transaction ID or type, etc.) that may have corresponding values allowing for determination of whether activities are shared by multiple accounts. Each one of activities 133 may correspond to a checkpoint in a data processing flow, such as a point in which data is collected, processed, and/or stored, which may correspond to a computing log that records the activity or data from the checkpoint.

At step 406, accounts between each account group are compared based on the traits for the different account activities. Comparisons 136 may be performed for account groups 135 by comparing activities 133 performed by accounts in the target account group to those performed by the contrast account group. Those activities that are shared and performed by at least a portion of the target account group, such as a number of accounts meeting or exceeding a threshold, may be identified for further analysis. This may further be limited to those account activity within the targeted account and/or using those accounts directly, however, other activities during the time period that be associated with the targeted accounts, such as performed by the contrast account group's accounts but with those in the target account group or other accounts with flags. Activities may be identified as being performed by the target account group and correlated to each other based on their traits that describe the activities, such as the variables. In this regard, the activities may be identified through trait combinations that have the same or similar traits for the corresponding activity.

At step 408, behavior patterns by the target account group are identified based on comparing the accounts. Behavior extractor tool 132 may generate activities trees 137 from the shared trait combinations of activities 133. Thereafter, a cross-activity search may be performed for shared one of activities 133 based on shared values for traits 134, and those activities that are shared between the targeted accounts, such by having the same ones of traits 134 having shared or same/similar values (e.g., a trait for a device or account ID is the same) may be identified, and those activities may be arranged into a pattern based on their time-based execution (e.g., based on the time-series data). As such, the time-series data may be used to determine an order or sequence of the activities, which may correspond to a behavior pattern for a specific account behavior that may be indicative of fraud or other behavior of interest.

At step 410, the behavior patterns are combined to identify those behavior patterns meeting a criteria or parameter for pattern identification. From the search of activity trees 137, identified patterns 138 may be determined. Identified patterns 138 may be validated or verified to meet one or more parameters for behavior pattern searching, such as minimum number of detected activities in the behavior pattern, or a threshold number of the accounts in the target account group over which one or more of the activities or the behavior pattern as a whole may be required to occur. Identified patterns 138 may then be marked or annotated, which may allow for AI model training, such as ML modeling or NN training. After model training, the models may generate output scores or decisions, and security operations may be executed to prevent and/or minimize abuse, fraud, and/or loss. For example, the security operation may, on detection of a verified risky sequence and behavior pattern, prevent use of the account including electronic transaction processing. The security operation may also issue manual challenges and/or multifactor authentication.

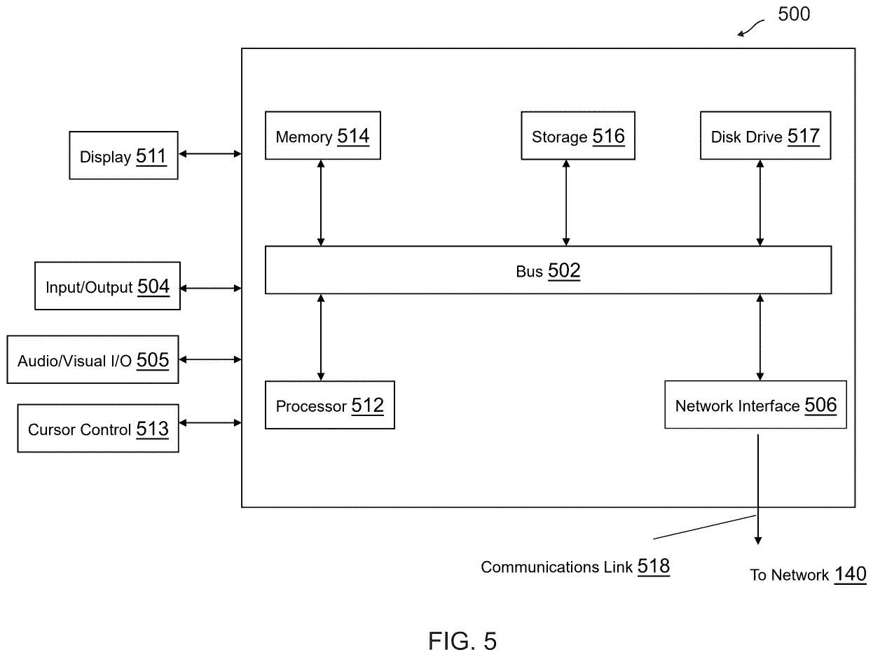

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, images, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output (I/O) component 505 may also be included to allow a user to use voice for inputting information by converting audio signals and/or input or record images/videos by capturing visual data of scenes having objects. Audio/visual I/O component 505 may allow the user to hear audio and view images/video including projections of such images/video. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to execute instructions to cause the system to:
receive an input of a first dataset comprising a plurality of account activities performed with a plurality of accounts over a first time period and a first parameter usable to identify a first behavior pattern, wherein the first dataset includes a first account group and a second account group of the plurality of accounts;
compare the plurality of account activities performed with the plurality of accounts in the first account group to the plurality of account activities performed with the plurality of accounts in the second account group based on a trait associated with each of the plurality of account activities that occurs during the first time period;
extract data for a plurality of behavior patterns for the first account group based on comparing the plurality of account activities performed, wherein the plurality of behavior patterns include at least two of the plurality of account activities sharing the trait during the first time period;
execute a search of the data for the plurality of behavior patterns for one or more combinations of the plurality of behavior patterns having shared activities with shared traits;
identify the first behavior pattern from the search; and
output an identification of the first behavior pattern based on the input of the first dataset, wherein the identification includes a subset of the shared activities and the shared traits in the first behavior pattern that meet the first parameter for identifying the first behavior pattern.

2. The system of claim 1, wherein the first dataset comprises time-series data for the plurality of account activities over the first time period in place of tabular data for the plurality of account activities.

3. The system of claim 2, wherein executing the instructions further causes the system to:
determine a second dataset comprising the time-series data for the plurality of account activities over a second time period;
determine whether the first behavior pattern occurs with one or more of the plurality of accounts during the second time period; and
output a notification based on determining whether the first behavior pattern occurs with one or more of the plurality of accounts during the second time period.

4. The system of claim 1, wherein the first account group is associated with one of fraudulent accounts or account takeovers, and wherein the second account group comprises a sampling of a set of accounts.

5. The system of claim 1, wherein executing the search of the data comprises:
identifying a plurality of activity trees each comprising a common activity that branches into one or more additional activities performed in a time sequence during the first time period;
combining two or more of the plurality of activity trees having overlapping branches in common; and
determining whether the overlapping branches occur at or over a threshold associated with the first parameter.

6. The system of claim 1, wherein, prior to comparing the plurality of account activities performed, executing the instructions further causes the system to
execute one or more data preparation processes on the input, wherein the one or more data preparation processes prepares data for the plurality of account activities usable by an analysis tool that compares each the plurality of account activities based on the trait.

7. The system of claim 1, wherein executing the instructions further causes the system to:
receive a second parameter usable to identify the first behavior pattern;
determine whether the first behavior pattern satisfies a condition associated with the second parameter; and
execute a further search of the data based on the determining whether the first behavior pattern satisfies the condition.

8. The system of claim 1, wherein identifying the first behavior pattern comprises determining a sequence of the at least two of the plurality of account activities sharing the trait occurring with a threshold number of the plurality of accounts in the first account group, wherein the threshold number is associated with the first parameter.

9. The system of claim 1, wherein the plurality of account activities are associated with checkpoints in computing process flows, and wherein the checkpoints comprise at least one of a login, an authentication, an add contact identifier, a password recovery, or a financial information change.

10. A method comprising:
comparing a plurality of account activities performed during a time period with a first plurality of accounts to the plurality of account activities performed during the time period with a second plurality of accounts based on a trait associated with each of the plurality of account activities, wherein the first plurality of accounts correspond to a target account group having an account activity indication, and wherein the second plurality of accounts correspond to a contrast account group corresponding to a general population of accounts;
identifying a plurality of behavior patterns of the first plurality of accounts based on two or more of the plurality of account activities each sharing a common trait that occurs during the time period;
combining the plurality of behavior patterns across the first plurality of accounts based on the common trait occurring during the time period; and
identifying a behavior pattern having the two or more of the plurality of account activities each with the common trait that occurs over a threshold number of the first plurality of accounts during the time period based on a parameter for pattern identification of the behavior pattern.

11. The method of claim 10, further comprising:
outputting the behavior pattern to an ML model training component; and
training an ML model by the ML model training component using at least the behavior patterns for an ML feature of the ML model.

12. The method of claim 10, wherein the identifying the plurality of behavior patterns utilizes a plurality of activity trees having the common trait shared when the two or more of the plurality of account activities were performed by at least a portion of the first plurality of accounts.

13. The method of claim 12, wherein, prior to the identifying, the method further comprises:
generating the plurality of activity trees based on a comparison of a number of occurrences of the common trait for the two or more of the plurality of account activities between the target account group and the contrast account group.

14. The method of claim 13, wherein the generating the plurality of activity trees is further based on the common trait occurring over a threshold difference between the target account group and the contrast account group.

15. The method of claim 10, wherein the identifying the plurality of behavior patterns is further based on comparing a number of temporally related occurrences of the two or more of the plurality of account activities associated with the target account group to the number of temporally related occurrences of the two or more of the plurality of account activities associated with the contrast account group.

16. A non-transitory machine-readable medium having stored thereon machine-readable instructions executable to cause a machine to perform operations comprising:
comparing a first plurality of accounts to a second plurality of accounts based on a plurality of traits associated with a plurality of account activities performed by one or more accounts in the first plurality of accounts and the second plurality of accounts during a time period;
determining a subset of the plurality of account activities performed by the one or more accounts in the first plurality of accounts over a threshold difference than the one or more of the accounts in the second plurality of accounts based on sharing one or more of the plurality of traits;
identifying a plurality of behavior patterns of the first plurality of accounts based on the subset of the plurality of account activities;
combining the plurality of behavior patterns based on the shared one or more of the plurality of traits; and
identifying a behavior pattern of the plurality of behavior patterns based on a threshold occurrence requirement from one or more parameters for pattern identification of the behavior pattern.

17. The non-transitory machine-readable medium of claim 16, wherein the operations further comprise:
outputting the behavior pattern to an ML model; and
training the ML model using at least the behavior pattern for an ML feature of the ML model.

18. The non-transitory machine-readable medium of claim 16, wherein the threshold difference comprises a threshold number or a threshold percentage of the subset of account activities occurring with the one or more accounts in the first plurality of accounts.

19. The non-transitory machine-readable medium of claim 16, wherein the identifying the plurality of behavior patterns comprises generating a plurality of activity trees from the subset of the plurality of account activities.

20. The non-transitory machine-readable medium of claim 19, wherein the plurality of activity trees comprise at least one of the plurality of activities linked based on one or more shared traits of the plurality of traits by a subset of the plurality of first accounts.
